(19) United States
(12) Patent Application Publication
(10) Pub. No.: US 2008/0241615 A1
(43) Pub. Date: Oct. 2, 2008

(54) HYDROGEN SUPPLY DEVICE, DISTRIBUTED POWER SUPPLY SYSTEM USING SAME, AND AUTOMOBILE USING SAME

(76) Inventors: Masatoshi Sugimasa, Tokai (JP); Takao Ishikawa, Hitachi (JP); Kohin Shu, Hitachi (JP); Atsushi Shimada, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/021,397

(22) Filed: Jan. 29, 2008

(30) Foreign Application Priority Data
Mar. 29, 2007 (JP) 2007-086324

(51) Int. Cl. H01M 8/18; F02B 43/08

(52) U.S. Cl. 429/20; 123/3

(57) ABSTRACT

There is provided a hydrogen storage and/or supply device utilizing an organic compound medium capable of being repeatedly hydrogenated and dehydrogenated. This device comprises: a catalyst member formed of a stack of a plurality of catalyst plates for storing and/or releasing hydrogen through a chemical reaction of the organic compound medium by means of a metal catalyst; a heat collector plate for supplying heat from a heat source to the catalyst member; and a heat transfer portion in contact with the plurality of catalyst plates and the heat collector plate. Each catalyst plate includes: the metal catalyst; a substrate; a catalyst support formed on at least one face of the substrate for supporting the metal catalyst; and a flow channel for passing the organic compound medium therethrough. Furthermore, the heat transfer portion has a thermal conductivity higher than that of the catalyst support.

### CLAIM OF PRIORITY

The present application claims priority from Japanese application serial no. 2007-086324 filed on Mar. 29, 2007, the content of which is hereby incorporated by reference into this application.

### BACKGROUND OF THE INVENTION

1. Field of the Invention

The present invention relates to hydrogen storage/supply devices for storing hydrogen and supplying it to distributed power sources such as an automobile and a home-use fuel cell.

2. Description of Related Art

With the growing concern over global warming due to greenhouse gases such as carbon dioxide, hydrogen has attracted attention as a next-generation energy source, which can replace fossil fuels. Cogeneration power systems have also received attention because they can reduce CO₂ (carbon dioxide) emission by making efficient use of energy and promoting energy conservation. In recent years, fuel cell power systems utilizing hydrogen have been successfully researched and developed as power sources for various applications such as automobiles, home power systems, vending machines and cellular phones. A fuel cell generates electricity by converting hydrogen and oxygen into water and simultaneously therewith also produces heat energy, which can be utilized for hot water supply or air conditioning, and thus it can be applied to a distributed power system for home use.

However, hydrogen, which is an essential fuel for such a system, has the crucial problems associated with the transportation, storage and supply thereof. Since hydrogen is a gas at room temperature, it is difficult to store and transport compared to liquid or solid materials. In a worse case, hydrogen gas is flammable and can explode at a certain mixing ratio thereof to air.

As a technology to solve such problems, there is known a power generation system in which hydrogen is supplied to a fuel cell in the following manner; at first, steam is added to a liquid hydrocarbon fuel to generate hydrogen, which is then temporarily stored in a hydrogen storage alloy; upon start-up, the stored hydrogen is released therefrom and is added to a hydrocarbon fuel to be hydrodesulfurized (hydrocracked); and the resulting hydrodesulfurized hydrocarbon is supplied to the fuel cell.

Recently, hydrogen storage systems (organic hydride systems) utilizing a hydrocarbon such as cyclohexane and decalin have also drawn attention because of their excellence in safety, transportability and ease of storage. Such hydrocarbons are liquid at room temperature and therefore have excellent transportability. For an example of benzene and cyclohexane both being a cyclic hydrocarbon with the same number of carbons, the former is an unsaturated one having some carbon-carbon double bonds, while the latter is a saturated one having no such double bond. Here, benzene is hydrogenated into cyclohexane, while conversely, cyclohexane is dehydrogenated into benzene. Therefore, storage and supply of hydrogen can be realized by utilizing the hydrogenation and dehydrogenation of such hydrocarbons. For example, JP-A-2006-248814 discloses a hydrogen supply system that utilizes such reaction in order to supply hydrogen to distributed power sources such as an automobile and home-use fuel cell. This JP-A-2006-248814 also discloses that waste heat from a fuel cell, engine or the like is utilized for a catalytic reaction.

However, in hydrogen storage/supply systems utilizing such hydrogenation and dehydrogenation reactions typified by the above-mentioned chemical conversion between benzene and cyclohexane, the chemical reaction efficiency is generally low, and therefore the overall system efficiency needs to be increased in order to supply hydrogen to distributed power sources such as an automobile and home-use fuel cell. One possible solution to this problem is the method described in the above-mentioned JP-A-2006-248814, which utilizes waste heat from a fuel cell, engine or the like for the catalytic reaction. However, in order to realize a hydrogen storage/supply device that occupies an only limited space and yet can supply a required amount of hydrogen, it needs a further increase in the reaction efficiency thereof. A possible approach to realize this is to increase the reaction surface area by stacking a plurality of catalyst supporting plates. However, in such a stack structure of catalyst supporting plates, the inner plates of the stack do not receive sufficient heat from a heat source. Hence, merely increasing the reaction surface area by employing a stack structure alone would fail to provide expected hydrogen generation. Further, increasing the stacked number of such plates presents a problem in that it is difficult to supply a fuel uniformly among the plates, thus possibly degrading the reaction efficiency.

### SUMMARY OF THE INVENTION

Under these circumstances, the present invention is originated to solve the above problems. It is an object of the present invention to provide a hydrogen storage device with a small size and high reaction efficiency.

(1) According to one aspect of the present invention, a hydrogen storage and/or supply device utilizing an organic compound medium capable of being repeatedly hydrogenated and dehydrogenated, which comprises: a catalyst member formed of a stack of a plurality of catalyst plates for storing and/or releasing hydrogen through a chemical reaction of the organic compound medium by means of a metal catalyst; a heat collector plate for supplying heat from a heat source to the catalyst member; and a heat transfer portion in contact with the plurality of catalyst plates and the heat collector plate, wherein each catalyst plate comprises: the metal catalyst; a substrate; a catalyst support formed on at least one face of the substrate and for supporting the metal catalyst; and a flow channel for passing the organic compound medium therethrough, and wherein the heat transfer portion has a thermal conductivity higher than that of the catalyst support.

In the above invention (1), the following modifications and changes can be made.

(i) The flow channel of the catalyst member has a depth within a range of 0.1 to 100 μm.

(ii) The flow channel of the catalyst member has a width within a range of 0.1 to 1000 μm.

(iii) In the flow channel of the catalyst plate is formed a depression, a protrusion, or a combination of a depression and a protrusion in order to control the flow of the organic compound medium flowing through the flow channel.

(iv) A through hole is formed in the flow channel of the catalyst plate in order to exchange and uniformly distribute the organic compound medium between vertically adjacent ones of the stacked catalyst plates.

(v) The heat transfer portion is bonded to each catalyst plate of the catalyst member and the heat collector plate.

(vi) The bonding of the heat transfer portion is performed by at least one method selected from a group consisting of friction stir welding, laser bonding, welding and brazing.

(vii) The heat transfer portion is a portion at which the stacked plates are bonded to each other; and the bonded portion is bonded to the heat collector plate.

(viii) The catalyst support includes a catalyst support made of a basic material.

(ix) The catalyst support includes a porous film.

(x) The metal catalyst is made of at least one metal selected from a group consisting of nickel, palladium, platinum, rhodium, iridium, ruthenium, molybdenum, rhenium, tungsten, vanadium, osmium, chromium, cobalt and iron.

(xi) The organic compound medium having released the hydrogen includes an aromatic compound.

(xii) The aromatic compound is at least one selected from a group consisting of benzene, toluene, xylene, mesitylene, naphthalene, methylnaphthalene, anthracene, biphenyl, phenanthrene, an alkyl- substituted derivative thereof and any mixture thereof.

(xiii) The catalyst support is provided on both faces of the substrate.

(xiv) The catalyst member is disposed in a casing; and the casing has a thermal conductivity higher than that of the catalyst support.

(xv) The heat collector plate has a well; and the catalyst member is fitted in the well.

(2) According to another aspect of the present invention, a distributed power supply system comprises: said hydrogen storage and/or supply device; and a generator or motor selected from a group consisting of a fuel cell, a turbine and an engine.

(3) According to another aspect of the present invention, a automobile comprises: said hydrogen storage and/or supply device; and a generator or motor selected from a group consisting of a fuel cell, a gas turbine and an internal combustion engine.

In the above inventions (2) and (3), the following modifications and changes can be made.

(xvi) Waste heat from the generator or motor is supplied to said hydrogen storage and/or supply device.

(xvii) Hydrogen is produced using electric power generated by the generator and is stored in the organic compound medium.

(Advantages of the Invention)

The present invention can provide a compact and high efficiency hydrogen storage device and system for supplying hydrogen to distributed power sources such as an automobile and a home-use fuel cell.

### BRIEF DESCRIPTION OF THE DRAWINGS

FIG. 1 is a schematic illustration showing an example of a hydrogen storage/supply system according to the present invention, in which are illustrated a house-use distributed power supply system utilizing a renewable energy with a utility electricity; and a hydrogen fueled vehicle.

FIG. 2 is a schematic illustration showing an example of configuration and appearance of a hydrogen storage/supply device in a first embodiment according to the present invention.

FIG. 3 is schematic illustrations for explaining an internal structure and a forming procedure of a catalyst member of hydrogen storage/supply device in a first embodiment according to the present invention.

FIG. 4 is a schematic illustration showing an appearance of a conventional hydrogen storage/supply device as Comparative example.

FIG. 5 is a schematic illustration showing a cross sectional view of an internal structure of the conventional hydrogen storage/supply device.

FIG. 6 is schematic illustrations for explaining an internal structure and a forming procedure of a catalyst member of a hydrogen storage/supply device in a second embodiment according to the present invention.

FIG. 7 is schematic illustrations for explaining an internal structure and a forming procedure of a catalyst member of a hydrogen storage/supply device in a third embodiment according to the present invention.

### DETAILED DESCRIPTION OF THE PREFERRED EMBODIMENTS

A hydrogen storage and/or supply device according to the present invention basically comprises: a catalyst member formed of a stack of multiple catalyst plates; a heat collector plate for supplying heat from a heat source to the catalyst member; and a heat transfer portion in contact with the multiple catalyst plates and the heat collector plate, wherein each catalyst plate includes: a metal catalyst; a substrate; a catalyst support formed on at least one face of the substrate and for supporting the metal catalyst; and a flow channel for passing an organic compound medium therethrough, and wherein the heat transfer portion has a thermal conductivity greater than that of the catalyst support.

In the hydrogen storage/supply device of the present invention, the organic compound medium (hereinafter simply referred to as “medium”) having stored hydrogen passes through the flow channels provided on the surfaces of the catalyst plates, where it undergoes dehydrogenation reaction. Hydrogen produced by the dehydrogenation reaction and the organic compound medium having released hydrogen are converged through the respective passages.

Since the dehydrogenation reaction is generally an endothermic reaction, it is necessary that heat be supplied to the multiple catalyst plates supporting the metal catalyst. This device of the present invention is characterized in that the heat collector plate collects heat from a heat source and supplies heat to the catalyst member via the heat transfer portion. The heat transfer portion is preferably bonded to the catalyst member and the heat collector plate in order to efficiently transfer heat from the heat source to the catalyst member. The heat transfer portion is not limited to any particular material or composition as long as it has a thermal conductivity greater than that of the catalyst support, and there may be used any of metal, metal alloy and carbon. The heat transfer portion may be a portion at which one of the catalyst plates of the catalyst member is bonded to another catalyst plate or a casing for containing the catalyst member, and which is further bonded to the collector plate. Preferably, the heat transfer portions are disposed in parallel with the flows of the organic compound medium and hydrogen so as not to block them and are also preferably extended across the entire width of the catalyst member so as to maximize the heat supply thereto. Too thin a heat transfer portion can not supply sufficient heat, while too thick one blocks the flow of the organic compound medium and hydrogen; therefore, the width thereof is preferably 1 to 50 mm, more preferably 5 to 20 mm. Mere contact of the heat transfer portion with the catalyst member does not provide sufficient heat transfer, and therefore some sort bonding means for providing a chemical bonding is preferred. Such bonding means includes friction stir welding (FSW), laser bonding, electrical resistance heating (Joule heating), welding, brazing and crimping. Among these means, FSW, electrical resistance heating (Joule heating) and crimping can perform bonding at relatively low temperatures and therefore are preferred because higher bonding temperatures may damage the catalyst member.

Preferable hydrogen storage and release media are aromatic compounds such as benzene, toluene, xylene, mesitylene, naphthalene, methylnaphthalene, anthracene, biphenyl, phenanthrene, alkyl-substituted derivatives thereof and any mixture thereof. Hereinafter, these materials are collectively referred to as “organic hydrides”. Hydrogen can be stored in these organic hydrides by hydrogenating the carbon-carbon double bonds thereof. Such hydrogenated hydrogen donors resume the original role as hydrogen acceptor by releasing hydrogen. That is, the above-described media provide a suitable carrier for hydrogen recycle. As a catalyst for the hydrogenation and dehydrogenation reactions of the media, there can be used known ones that have been researched and developed well, and have been put into practical use. The present invention preferably uses catalysts by means of which the hydrogenation and dehydrogenation reactions can be carried out at lower temperatures in order to improve overall system efficiency.

The structural elements and fabrication steps of a hydrogen storage/supply device according to the present invention will be described below.

The catalyst plate includes: the metal catalyst and the catalyst support formed on the substrate; and the flow channel for passing the organic compound medium (organic hydrides) therethrough. As the substrate, there can be used: ceramics such as aluminum nitride, silicon nitride, alumina and mullite; carbon materials such as graphite sheet; metal materials (including cladding materials) such as copper, nickel, aluminum, silicon and titanium; films of heat-resistant polymers such as polyimide; and any combination thereof. The greater the thermal conductivity of the substrate and the less its thickness, the more efficiently the waste or combustion heat can be utilized to heat the catalyst layer (the metal catalyst and catalyst support). The present invention utilizes waste heat and/or combustion heat of unreacted gas from a high-temperature system such as a fuel cell, and can quickly transfer the heat to the catalyst layer. In particular, since dehydrogenation reaction is an endothermic reaction, the catalyst temperature is prone to fall with the progress of the reaction, thereby lowering the reaction rate. However, use of the substrate with a high thermal conductivity according to the present invention can prevent such catalyst temperature decrease.

As materials for the catalyst support, there can be used activated carbon, carbon nanotube, silica, alumina alumina-silicate such as zeolite, etc. When carrying out hydrogenation below 200° C., there can also be used basic oxides such as alumina, zinc oxide, silica, zirconium oxide and diatomaceous earth. These materials can also be used in combination. The catalyst support can be formed, e.g., using a solution process such as sol-gel, plating and anodizing, or a dry process such as thermal evaporation deposition, sputtering and CVD (chemical vapor deposition).

Aluminum or aluminum cladded metal is advantageously used as the substrate of the catalyst member, because porous alumina as a catalyst support can be directly formed on the surface of the aluminum by anodizing, thus improving the adhesiveness and thermal conductance between the substrate and the catalyst support. As the catalyst support there is more advantageously used a layer formed by anodizing an aluminum surface and then enlarging the resulting pores produced by the anodizing followed by boehmite treatment and baking, because the surface area of the catalyst support can be increased, thereby increasing the catalyst loading compared to anodizing alone (described later in detail). Furthermore, pores of a porous catalyst support produced by anodizing can be filled with another catalyst support such as a basic oxide and activated carbon, thereby adjusting the surface acidity or the fuel adsorbing ability of the catalyst. The aluminum clad non-aluminum metal can be formed by applying an aluminum layer by, e.g., non-aqueous plating, crimping, thermal evaporation deposition and dipping, on the surface of: a plate made of a metal such as Mg (magnesium), Cr (chromium), Mo (molybdenum), W (tungsten), Mn (manganese), Fe (iron), Co (cobalt), Ni (nickel), Ti (titanium), Zr (zirconium), V (vanadium), Cu (copper), Ag (silver), Zn (zinc), Bi (bismuth), Sn (tin), Pb (lead) and Sb (antimony), or a metal alloy thereof; a laminate of multiple metal plates; a spongy metal plate; etc.

As an anodizing electrolyte, there can be used aqueous solutions of acids such as phosphoric acid, chromic acid, oxalic acid and sulfuric acid. Among these, aqueous solutions of phosphoric acid, chromic acid and oxalic acid are preferred in order to prevent catalyst poisoning. The pore size and thickness of a porous layer produced by anodizing can be appropriately adjusted by controlling the anodizing conditions such as application voltage, processing temperature and time. The pore size and thickness are preferably 10 to 300 nm and 5 to 300 μm, respectively. The anodizing electrolyte temperature is preferably 0 to 50° C., more preferably 30 to 40° C. The anodizing time varies depending on the other processing conditions and required thickness. For example, when aluminum is anodized in a 4 mass % aqueous oxalic acid electrolyte at a processing temperature of 30° C. at an applied voltage of 40 V for 7 hours, the resulting anodized layer has a thickness of 100 μm.

The anodized layer is further surface treated using an aqueous acid such as phosphoric acid and oxalic acid in order to enlarge the pores produced, and is then boehmite treated. For example, the aqueous phosphoric acid preferably has a concentration of 5 to 20 mass %, and the surface treatment is preferably carried out at 10 to 30° C. for 10 minutes to 3 hours until the pores have been enlarged to a required size. Alternatively, an anodized aluminum can be left dipped in an anodizing bath for a predetermined period of time to carry out the pore enlargement. The boehmite treatment is carried out in hot water or pressurized steam (50 to 200° C.) having a pH of 6 or more, preferably 7 or more, followed by drying and baking. Duration of the boehmite treatment is preferably 5 minutes or more, although it varies depending on the pH and processing temperature. For example, it is about 2 hours in the case of water having a pH of 7. The baking is for forming γ-alumina, and is typically carried out at 300 to 550° C. for 0.5 to 5 hours.

As the metal catalyst, there can be used a metal such as Ni, Pd (palladium), Pt (platinum), Rh (rhodium), Ir (iridium), Re (rhenium), Ru (ruthenium), Mo, W, V, Os (osmium), Cr, Co and Fe, and an alloy thereof. The method of forming the metal catalyst includes, but is not limited to, co-precipitation method and pyrolysis method.

The form of the catalyst plate is not particularly limited but may be a plate, rod, sphere or powder. Among these, the present invention preferably adopts a plate form in consideration of ease of handling and heat transfer efficiency. Further, in order to downsize a reactor, the catalyst member is formed of a stack of plural catalyst plates, each distributing, on at least one face thereof, a metal catalyst for promoting hydrogenation and/or dehydrogenation of a hydrogen storage medium.

The catalyst plate is provided with a flow channel for passing the hydrogen storage medium therethrough. There is no particular limitation on the manufacturing method and form of the flow channel. One method of providing the flow channel is to form it in the substrate. When forming a groove flow channel in the substrate, there can be used chemical etching with a solution, dry etching, molding, machining, etc. With these methods, projection and depression structures of various shapes can be formed in the flow channel simultaneously with the flow channel formation, and are therefore advantageous in terms of fabrication efficiency and design flexibility. Alternatively, the flow channel may be formed using a spacer. A flow channel too small in size may not provide a sufficiently smooth flow of the medium, while too large one may create wasted space and are therefore disadvantageous in terms of apparatus size and reaction efficiency. In consideration of this, the flow channel is preferably 1 to 1000 μm in depth and 1 to 1000 μm in width. Particularly, its depth is preferably 10 to 100 μm.

Control of the medium flow is important for increasing reaction efficiency because, e.g., a flow channel having flat surfaces tends to cause laminar flow and create regions that do not contribute to the reaction. While there is no limitation on the control method of the medium flow, it is easy and therefore preferable to form a projection and depression structure in the flow channel, thereby causing turbulent flow and uniformly stirring the organic compound medium throughout the flow channel. The dimensions and shape of the projection and depression structure need to be designed for each device because their optimums depend on the properties of the organic compound medium and size of the flow channel. In the stack structure of multiple catalyst plates, difficulty in supplying the organic compound medium uniformly among the catalyst plates may deteriorate reaction efficiency. Hence, it is preferred to form a through hole in the catalyst plate, thereby promoting mixing of the organic compound medium and equalizing the concentration thereof among the plates.

The present invention can firstly form a large size catalyst plate and then cutting it out into multiple catalyst plates of a desired size, which are then stacked and integrated into the hydrogen storage/supply device. The outer periphery of the hydrogen storage/supply device is required to be sealed. The sealing is carried out, e.g., by sandwiching the stack of the catalyst plates between metal plates and bolting the periphery thereof, or by using a sealing material. There is no particular limitation on the sealing material as long as it can prevent leakage of hydrogen and fluid of the organic compound medium, and there can be used, e.g., metal, ceramic, glass and resin. The sealing process can be carried out by, e.g., coating or melting method. When using a surface mounting material such as solder, as a sealing material, there can be employed mounting processes such as reflow.

The hydrogen storage/supply device according to the present invention has a microreactor structure and, in order to suppress a very rapid temperature drop of the catalyst layer due to endothermic dehydrogenation reaction, supplies heat to the catalyst member through a heat transfer portion bonded to thereinside, thereby enabling a fast hydrogen generation. In addition, reaction within such small spaces allows efficient hydrogen generation. Further, metal catalyst nanoparticles are applied to the catalyst basic support with a micro- or nano-scale on the surfaces of the catalyst plate, which increases the surface area to volume ratio (specific surface area) of the catalyst layer, thereby enhancing contact frequency between an organic hydride and the catalyst layer. This enables efficient catalyst utilization, which in turn increases reaction rate.

A larger size flow channel has a thicker fluid portion and a smaller ratio of the mixed interface. Therefore, by reducing the flow channel size, the fluid portion thickness can be reduced and the mixed interface ratio can increase. In addition, there exist nano-scale pores on the catalyst layer surfaces and in the porous film formed adjacent to the catalyst layer. A liquid drop has a higher vapor pressure with decreasing a droplet diameter and therefore vaporizes more readily even at lower temperatures. Combining the smaller liquid drop with the nano-pores can form a micro-scale mixed interface, thereby providing efficient progress of the dehydrogenation reaction even at lower temperatures. A micro space tends to cause a laminar liquid flow; however, the projection and depression structure formed on the flow channel surface and/or the through hole provided in the catalyst plate promotes mixing between a flow layer on the catalyst surface where the reaction proceeds and a bulk flow layer through which the medium fluid merely flows, thereby enhancing the reaction efficiency.

The hydrogen storage/supply device described above can be connected to a fuel cell to provide a power generation system. In the hydrogen storage/supply device according to the present invention, the dehydrogenation reaction of an organic hydride can take place even at 250° C. or less. Combining the hydrogen storage/supply device of the present invention with a fuel cell, waste heat from the fuel cell or combustion heat obtained by burning unreacted hydrogen gas can be utilized to reduce the burden of a heater for heating the hydrogen storage/supply device, thereby achieving downsizing and increasing efficiency of overall system. A phosphoric acid fuel cell and polymer electrolyte fuel cell exhaust waste heat of 150 to 220° C. and 80 to 150° C., respectively. When combined with these fuel cells, such waste heat or combustion heat obtained by burning unreacted hydrogen gas can be utilized to efficiently operate the hydrogen storage/supply device. On the other hand, a molten carbonate fuel cell and solid oxide fuel cell exhaust waste heat of 600 to 700° C. and approximately 1000° C., respectively. When used with these fuel cells, hydrogen can be supplied without any heater by appropriately placing the hydrogen storage/supply device or by using a heat exchanger.

The hydrogen storage/supply device of the present invention can be collectively sealed around the entire periphery thereof with a sealing material, thereby allowing compact and thin design. The organic compound medium can be supplied with, e.g., a pump and a mass flow meter for controlling its supply rate.

When combined with a fuel cell or the like, the hydrogen storage/supply device of the present invention is preferably installed at an appropriate position where waste heat can be efficiently utilized. In this case, the heat collector plate of the hydrogen storage/supply device is disposed in a vicinity where waste heat of the fuel cell is exhausted. More specifically, when used with, e.g., a polymer electrolyte fuel cell, the heat transfer portion is preferably placed in contact with the casing of a heat exchanger for exchanging heat with exhaust from the fuel cell stack. A home-use fuel cell circulates water through a heat exchanger for supplying hot water. In this case, an organic hydride can also be circulated through another heat exchanger to cool the fuel cell stack and to protect its electrolyte membrane from thermal damage as well as to pre-heat the organic hydride. In addition, the hot water from the heat exchanger or steam from the power generators can be utilized to humidify air to be supplied to the fuel cells. In the case of a fuel cell for automotive use, steam produced in the power generation alone is sufficient for humidifying air to the fuel cell, and therefore a heat exchanger can be used exclusively for circulating an organic hydride and pre-heating it. In the case of a fuel cell for automotive use, waste heat to be utilized is also exhausted from a compressor for supplying air to the cathode.

Preferred embodiments according to the present invention will be described bellow with reference to the accompanying drawings. However, the present invention is not limited to the embodiments described herein.

### First Embodiment of the Invention

(Hydrogen Storage/Supply System)

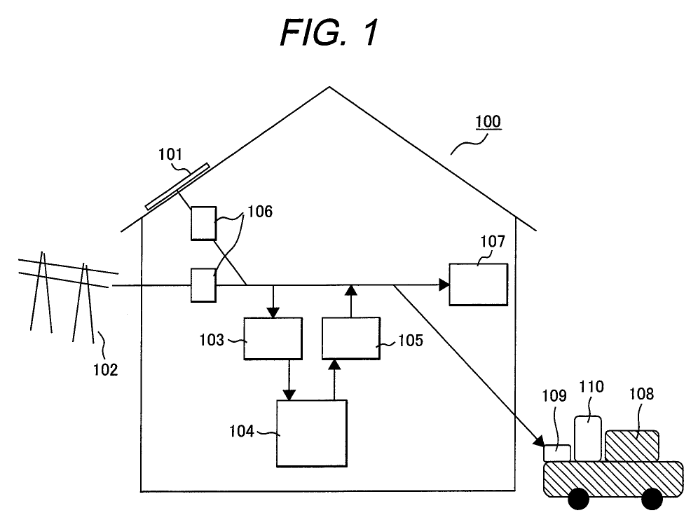

FIG. 1 is a schematic illustration showing an example of a hydrogen storage and supply system according to the present invention, in which are illustrated a home-use distributed power supply system utilizing a renewable energy with a utility electricity; and a hydrogen fueled vehicle. The hydrogen storage and supply devices in this embodiment function as part of this system. A home 100 includes: solar cells 101 on the roof or other places; a utility electricity supply 102; a water electrolyzer 103; a hydrogen storage and supply device 104; and a fuel cell system 105. Electric power generated from a renewable energy source such as the solar cells 101 is converted to AC (alternating current) by an inverter 106. The converted electricity is used in an electric household appliance 107. Excess power that has not been used by the appliance 107 is supplied to the water electrolyzer 103. On a vehicle 108 are mounted a vehicle-use hydrogen storage and supply device 109 and a vehicle-use fuel cell system 110.

The water electrolyzer 103 produces hydrogen and oxygen by water electrolysis. The hydrogen produced is sent to the hydrogen storage and supply device 104, where a dehydrogenated aromatic compound is hydrogenated (into an organic hydride) for reuse as hydrogen storage medium.

Power supplies are classified into: peak power supply that varies depending on load variations in daytime; and baseline power supply that is constant at any time day or night. The power supply system in FIG. 1 is a power source for supplying peak power which varies depending on load variations in daytime, while the utility electricity 102 provided by a power company or the like is utilized for the baseline power supply. Preferably, the utility electricity 102 is also generated from renewable energies for CO₂ emission reduction. Various renewable energies can be utilized other than solar energy such as wind, geothermal, ocean thermal, tidal and biomass energy. Solar energy is available only during daytime, while the other renewable energies mentioned above are available also during nighttime for power generation. Power consumption drastically drops during night as compared to during the day; so, fossil fuel based thermal power station or the like may stop or diminish the operation for a while at night for fuel consumption reduction. By contrast, since renewable energies involve no fuel cost, they can also generate power if possible during nighttime without causing the above-mentioned cost problem. However, there is a great chance of excess power being generated at night when less power is consumed. In this case, the excess power generated is used to produce hydrogen by water electrolysis, and then the hydrogen storage/supply devices 104 and 109 according to the present invention are used to store the resulting hydrogen in the form of an organic hydride. The hydrogen stored in the form of an organic hydride is in turn used as fuel for, e.g., the fuel cell in FIG. 1. During daytime, power generated from renewable energies is made maximum use for the peak power supply.

The vehicle 108 is driven by an electric motor powered by the vehicle-use fuel cell system 110, to which hydrogen is supplied from the hydrogen storage/supply device 109 that dehydrogenates an organic hydride. Similarly to the home-use distributed power supply system, the vehicle 108 may also include its own water electrolyzer 103 and may activate the vehicle-use hydrogen storage and supply device 109 using the nighttime power supply in order to store the hydrogen in the form of an organic hydride.

(Configuration and Manufacturing Method of Hydrogen Storage/Supply Device)

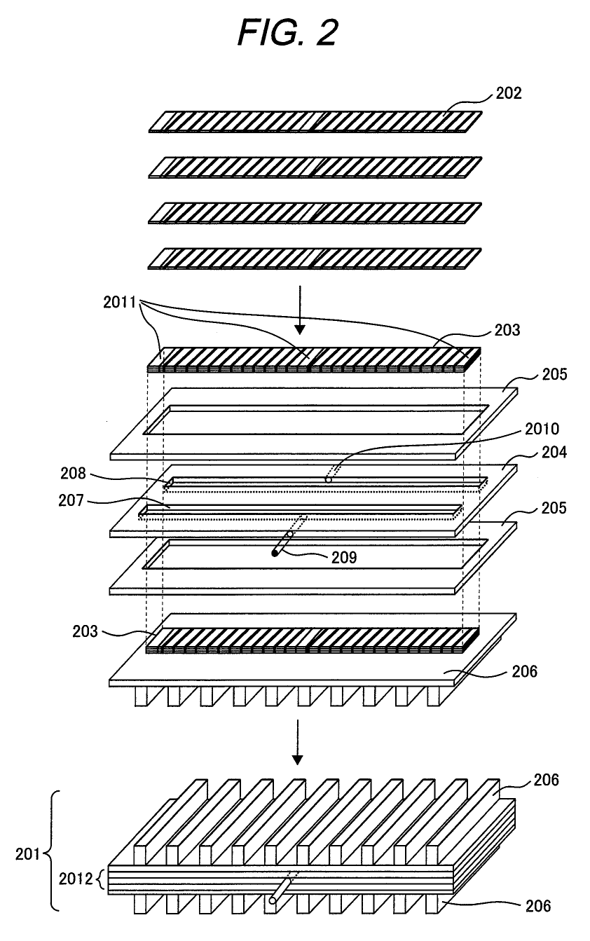

FIG. 2 is a schematic illustration showing an example of configuration and appearance of a hydrogen storage/supply device in a first embodiment according to the present invention. The hydrogen supply device 201 in this embodiment includes: a catalyst member 203 formed by stacking catalyst plates 202 having 5 mass % Pt/alumina catalyst layer; a medium distribution plate 204 made of SUS (stainless steel); spacers 205; heat collector plates 206 made of Al (aluminum); a medium passage 207 and a hydrogen passage 208 formed in the plate 204; and a medium inlet 209 and a hydrogen outlet 2010, both bonded to the plate 204. Three heat transfer portions 2011 are bonded in the stack-structured catalyst member 203 in order to spread heat thereacross. In this embodiment, flow channels having a depth of 100 μm are formed in the catalyst plate 202, where the catalyst layer of 5 mass % Pt/alumina is disposed. In addition, in order to control the medium flow, protrusion walls having a width of 50 μm are provided at a spacing of 300 μm in such a manner to partition the flow channel. Further, pluralities of 5-mm-diameter through holes are provided at the central portion of the conduit in order to equalize the medium concentration among the catalyst plates.

In this embodiment device, firstly, there are prepared a desired number of catalyst plates 202 each having a catalyst layer of 5 mass % Pt/alumina formed on a substrate made of an Al plate, and then they are stacked and bonded to each other to form the catalyst member 203. These bonded portions serve as the heat transfer portions 2011 in this embodiment. Next, the catalyst member 203 is placed on one heat collector plate 206, portions of which are then bonded to the heat transfer portions 2011. Next, the catalyst member 203 bonded to the heat collector plate 206 is fitted in a casing 2012 that is formed by bonding the medium distribution plate 204 and the spacer 205. Finally, another heat collector plate 206 is bonded to the catalyst member 203 fitted in the casing 2012, and then the outer periphery of the resulting assembly is sealed, thereby obtaining the hydrogen storage and supply device 201.

An organic hydride passes through the medium passage 207 in the medium distribution plate 204 and the flow channels in the catalyst plates 202 (stack-structured catalyst member 203) having 5 mass % Pt/alumina catalyst layer, during which it is dehydrogenated to produce hydrogen on the surfaces of Pt supported by alumina. The hydrogen produced passes through the hydrogen passage 208 and the hydrogen outlet 2010 to be supplied to an external fuel cell or the like.

(Method for Forming Catalyst Member)

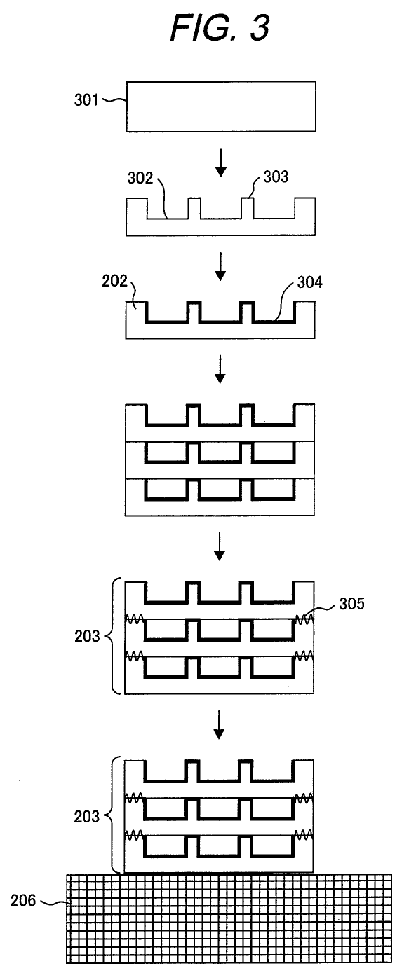

A method for forming the catalyst member 203 will be described in detail with reference to FIG. 3. FIG. 3 is schematic illustrations for explaining an internal structure and a forming procedure of a catalyst member of hydrogen storage/supply device in a first embodiment according to the present invention. As shown in FIG. 3, in the surface of an Al substrate 301 of 60 mm×300 mm and 1 mm thick are formed, by etching, a flow channel 302 and protrusions 303 serving as walls for partitioning the flow channel. Thereon is applied an alumina sol 304 admixed with Pt particles, which is then baked for one hour at 450° C., thereby obtaining the catalyst plate 202. The catalyst layer (the metal catalyst and catalyst support) is approximately 0.5 μm thick and has protrusions and depressions conforming to the underlying flow channel. Then, three such catalyst plates 202 are stacked and bonded, by welding, to each other at welded portions 305 (four portions in FIG. 3), thereby obtaining the catalyst member 203. Meanwhile, the multiple through holes are preformed in the Al substrate 301 by lathe machining.

For the spacer 205, a 4-mm-thick SUS304 (stainless steel type 304) plate is used. The medium distribution plate 204 is provided by forming the medium and hydrogen passages in a 8-mm-thick SUS304 plate, and then thereto are welded the spacer 205, and the medium inlet 209 and hydrogen outlet 2010 each formed of a ⅛ inch diameter pipe, thereby obtaining the casing 2012. The catalyst member 203 is welded to the heat collector plate 206 formed of a 1-mm-thick Al plate, which are together fitted in and on the casing 2012, and then the outer periphery of the resulting assembly is sealed with a sealing material.

(Hydrogen Supply Test)

The hydrogen storage/supply device in this embodiment has dimensions of, e.g., 80 mm (width)×320 mm (length)×10 mm (thickness). This device was placed on a ceramic heater playing a role of an external heat source in such a manner that its heat collector plate 206 contacts the heater, and was heated up to 250° C. As the hydrogen storage medium, 1-methyldecahydronaphthalene was used. It was introduced in the device to be dehydrogenated. The result was that the hydrogen generation rate achieved a maximum value of 18 L/min per 1 g of Pt at a medium supply pulse interval of 25 sec. As mentioned above, because the hydrogen storage/supply device of the present invention is configured with a high thermal conducting material capable of efficiently transferring heat from an external heat source to its catalyst layer, the metal catalyst in the catalyst member can be heated efficiently, and therefore accelerating the dehydrogenation reaction. In addition, this embodiment device is provided with the protrusions in the flow channel and is further provided with the through holes that allow the medium to flow up and down to adjacent catalyst plates. These can control distribution and concentration of the medium supply to the metal catalyst in a plane of the catalyst plate and also among the catalyst plates, thereby enhancing efficiency of the dehydrogenation reaction.

### COMPARATIVE EXAMPLE

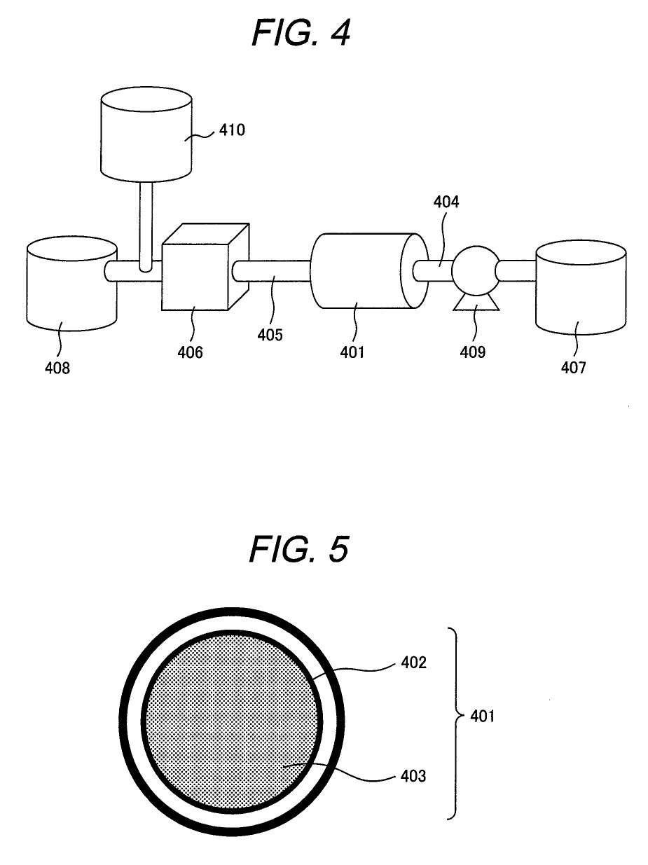

FIG. 4 is a schematic illustration showing an appearance of a conventional hydrogen storage/supply device as Comparative example; and FIG. 5 is a schematic illustration showing a cross sectional view of an internal structure of the conventional hydrogen storage/supply device. A hydrogen storage/supply device 401 is formed in a stainless steel pipe casing with a diameter of 15 mm, a length of 50 mm and a wall thickness of 2 mm. As shown in FIG. 5, the device casing contains thereinside a 10-mm-diameter, 50-mm-long, 80-μm-wall-thickness palladium pipe 402, which is filled with, as a catalyst layer 403, 10 g of 5 mass % Pt/activated carbon. To the hydrogen storage/supply device 401 are connected: an organic compound medium inlet 404; and a hydrogen outlet 406 via an organic compound medium outlet 405. The organic compound medium inlet 404 and organic compound medium outlet 405 are connected to a organic compound medium tank 407 and a waste tank 408, respectively. The organic compound medium is fed using a pump 409. The hydrogen storage/supply device 401 was heated up to 250° C. using a heater (not shown), which was placed outside the device and served as an external heat source. Methylcyclohexane, which was used as the organic compound medium, was fed into the device, where it was dehydrogenated. The result was that the hydrogen generation rate was as small as only 2 L/min per 1 g of Pt. This is probably because the hydrogen storage/supply device 401 could not allow the organic compound medium to be sufficiently evaporated due to a large size flow channel and therefore hampered proper formation of a gas-liquid-solid mixed interface on the catalyst surface. Further, hydrogen separation membranes are not provided adjacent to the catalyst layer but rather along the outer periphery thereof in this Comparative example; it therefore seems that hydrogen could not be separated sufficiently quickly by the membranes to reduce the hydrogen partial pressure, thereby lowering the conversion rate of the dehydrogenation reaction.

### Second Embodiment of the Invention

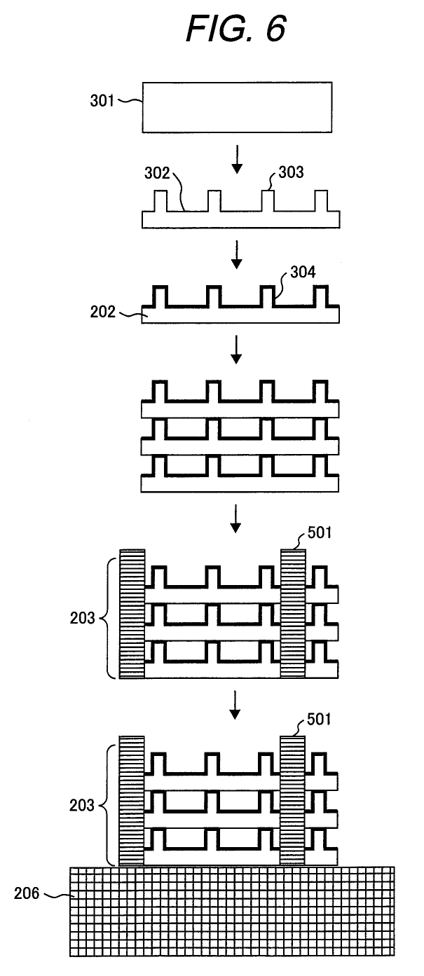

In a second embodiment of the present invention, the catalyst member of the hydrogen storage/supply device uses different material for a heat transfer portion thereof from that for the catalyst plate, while the heat transfer portion and the catalyst plate are made of the same material in the first embodiment. FIG. 6 is schematic illustrations for explaining an internal structure and a forming procedure of a catalyst member of a hydrogen storage/supply device in a second embodiment according to the present invention. The catalyst member 203 of this embodiment has a similar configuration to that of the first embodiment. However, a heat transfer portion 501 is made of AlN (aluminum nitride) with high thermal conductivity. AlN plates of 10 mm wide and 50 mm long are inserted into slots formed in the stacked catalyst plates and are bonded thereto by FSW. The resulting catalyst member is stacked on a 1-mm-thick Al heat collector plate 206, and then the AlN plates of the catalyst member and the Al plate (heat collector plate 206) are bonded by FSW. This is then mounted in a casing 2012 and the outer periphery of the resulting assembly is sealed with a glass sealing material.

The result of a dehydrogenation test similar to that described in the first embodiment showed that the hydrogen generation rate achieved a maximum value of 19.2 L/min per 1 g of Pt at a medium supply pulse interval of 25 seconds. A probable explanation for this good result is that the hydrogen storage/supply device of this embodiment is configured with a high thermal conducting material capable of efficiently transferring heat from an external heat source to its catalyst layer, and therefore can efficiently heat the metal catalyst and accelerate the dehydrogenation reaction.

### Third Embodiment of the Invention

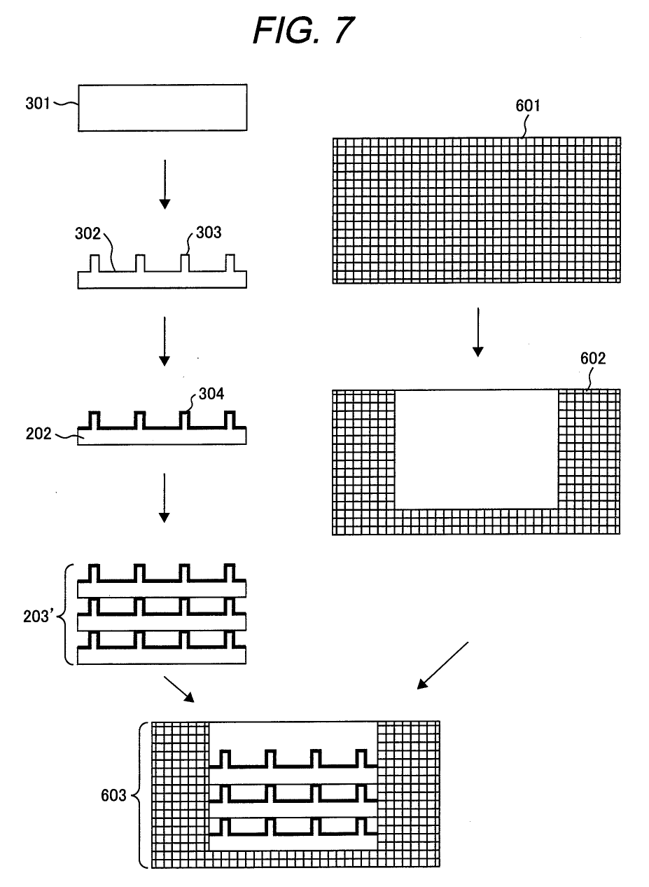

In a hydrogen storage/supply device of a third embodiment, the heat transfer portion of the catalyst member thereof is formed of part of a heat collector plate. FIG. 7 is schematic illustrations for explaining an internal structure and a forming procedure of a catalyst member of a hydrogen storage/supply device in a third embodiment according to the present invention. Stacked catalyst plates 203′ in this embodiment has a similar configuration to that in the second embodiment. While, in a 4-mm-thick Al heat collector plate 601 is formed, by etching, a well for fitting stacked catalyst plates 203′ therein, and the walls 602 thereof are used as a heat transfer portion. The stacked catalyst plates 203′, formed by a method similar to that described in the first embodiment, is bonded to the walls of the collector plate well by electrical resistance heating, thereby configuring a catalyst member 603. Thereafter, the outer periphery of the assembly of the catalyst member 603, the collector plate 206 and a casing 2012 is sealed with a glass sealing material.

The result of a dehydrogenation test similar to that described in the first embodiment showed that the hydrogen generation rate achieved a maximum value of 16.9 L/min per 1 g of Pt at a medium supply pulse interval of 25 seconds. This good result can probably be explained by the fact that the hydrogen storage/supply device of this embodiment is configured with a high thermal conducting material capable of efficiently transferring heat from an external heat source to its catalyst layer, and therefore can efficiently heat the metal catalyst and accelerate the dehydrogenation reaction.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A hydrogen storage and/or supply device utilizing an organic compound medium capable of being repeatedly hydrogenated and dehydrogenated, comprising:
a catalyst member formed of a stack of a plurality of catalyst plates for storing and/or releasing hydrogen through a chemical reaction of the organic compound medium by means of a metal catalyst;
a heat collector plate for supplying heat from a heat source to the catalyst member; and
a heat transfer portion in contact with the plurality of catalyst plates and the heat collector plate, wherein each catalyst plate comprises:
the metal catalyst;
a substrate;
a catalyst support formed on at least one face of the substrate for supporting the metal catalyst; and
a flow channel for passing the organic compound medium therethrough, and wherein the heat transfer portion has a thermal conductivity greater than that of the catalyst support.

2. The hydrogen storage and/or supply device according to claim 1, wherein:
the flow channel of the catalyst member has a depth within a range of 0.1 to 100 μm.

3. The hydrogen storage and/or supply device according to claim 1, wherein:
the flow channel of the catalyst member has a width within a range of 0.1 to 1000 μm.

4. The hydrogen storage and/or supply device according to claim 1, wherein:
in the flow channel of the catalyst plate is formed a depression, a protrusion, or a combination of a depression and a protrusion in order to control the flow of the organic compound medium flowing through the flow channel.

5. The hydrogen storage and/or supply device according to claim 1, wherein:
a through hole is formed in the flow channel of the catalyst plate in order to exchange the organic compound medium between vertically adjacent ones of the stacked catalyst plates.

6. The hydrogen storage and/or supply device according to claim 1, wherein:
the heat transfer portion is bonded to each catalyst plate of the catalyst member and the heat collector plate.

7. The hydrogen storage and/or supply device according to claim 6, wherein:
the bonding of the heat transfer portion is performed by at least one method selected from a group consisting of friction stir welding, laser bonding, welding and brazing.

8. The hydrogen storage and/or supply device according to claim 1, wherein:
the heat transfer portion is a portion at which the stacked plates are bonded to each other; and the bonded portion is bonded to the heat collector plate.

9. The hydrogen storage and/or supply device according to claim 1, wherein:
the catalyst support includes a catalyst support made of a basic material.

10. The hydrogen storage and/or supply device according to claim 1, wherein:
the catalyst support includes a porous film.

11. The hydrogen storage and/or supply device according to claim 1, wherein:
the metal catalyst is made of at least one metal selected from a group consisting of nickel, palladium, platinum, rhodium, iridium, ruthenium, molybdenum, rhenium, tungsten, vanadium, osmium, chromium, cobalt and iron.

12. The hydrogen storage and/or supply device according to claim 1, wherein:
the organic compound medium having released the hydrogen includes an aromatic compound.

13. The hydrogen storage and/or supply device according to claim 12, wherein:
the aromatic compound is at least one selected from a group consisting of benzene, toluene, xylene, mesitylene, naphthalene, methylnaphthalene, anthracene, biphenyl, phenanthrene, an alkyl-substituted derivative thereof and any mixture thereof.

14. The hydrogen storage and/or supply device according to claim 1, wherein:
the catalyst support is provided on both faces of the substrate.

15. The hydrogen storage and/or supply device according to claim 1, wherein:
the catalyst member is disposed in a casing; and the casing has a thermal conductivity higher than that of the catalyst support.

16. The hydrogen storage and/or supply device according to claim 1, wherein:
the heat collector plate has a well; and the catalyst member is fitted in the well.

17. A distributed power supply system, comprising:
the hydrogen storage and/or supply device according to claim 1; and
a generator or motor selected from a group consisting of a fuel cell, a turbine and an engine.

18. The distributed power supply system according to claim 17, wherein:
waste heat from the generator or motor is supplied to the hydrogen storage and/or supply device.

19. The distributed power supply system according to claim 17, wherein:
hydrogen is produced using electric power generated by the generator and is stored in the organic compound medium.

20. An automobile, comprising:
the hydrogen storage and/or supply device according to claim 1; and
a generator or motor selected from a group consisting of a fuel cell, a gas turbine and an internal combustion engine.
